(19) United States
(12) Patent Application Publication
(10) Pub. No.: US 2008/0226417 A1
(43) Pub. Date: Sep. 18, 2008

(54) Spring Nut

(75) Inventor: Uwe Spitz, Rheinfelden (DE)

Correspondence Address: BAKER & DANIELS LLP;111 E. WAYNE STREET, SUITE 800, FORT WAYNE, IN, 46802, US

(73) Assignee: A.RAYMOND ET CIE, Grenoble (FR)

(21) Appl. No.: 11/914,238

(22) PCT Filed: Apr. 20, 2006
(86) PCT No.: PCT/EP06/03597

§ 371 Date: Nov. 13, 2007

(30) Foreign Application Priority Data
May 30, 2005 (DE) 10 2005 024 712.1

(51) Int. Cl. F16B 37/02; F16B 37/08

(52) U.S. Cl. 411/170

(57) ABSTRACT

A spring nut to be fastened to a bolt comprises a frame (1) to which are attached two mutually opposite resilient clamping legs (5, 6). Also present is a locking leg (9), which is attached by one end bendably about¹ the frame (1) and which in a closed position comes into engagement with a holding arrangement (13, 14). In the closed position, the locking leg (9) exerts on at least one clamping leg (5, 6) a closing force that leads to a holding force holding the spring nut on the bolt. As a result, despite relatively high nominal holding forces, the mating and withdrawal forces for mating the spring nut onto and removing it from the bolt are comparatively low.

### BACKGROUND OF THE INVENTION

1. Field of the Invention

The invention relates to a spring nut.

2. Description of the Related Art

A prior spring nut is known from DE 197 33 771 C1. In the prior spring nut, attached to a frame are two mutually opposite, resilient clamping legs, which protrude into a recess of the frame and serve to bring about engagement with a bolt, particularly a threaded bolt, such that the spring nut can be connected to a supporting part by means of the bolt, for example during the apposition of an add-on part.

### SUMMARY OF THE INVENTION

The object underlying the invention is to provide a spring nut, which is distinguished by a very low mating force, a very high holding force and, assuming that the spring nut is to be removed from the bolt, a withdrawal force which, again, is very low.

By virtue of the fact that the inventive spring nut comprises a locking leg that acts on at least one clamping leg to generate the holding force and in a closed position comes into engagement with a holding arrangement and is thereby fixed in said closed position, the spring nut according to the invention can be slid onto the bolt with a very low mating force, whereas in the closed position of the locking leg the spring nut exerts a relatively high holding force on the bolt, and, after disengagement of the locking leg from the holding arrangement, permits removal from the bolt with a relatively low withdrawal force.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a perspective view of an exemplary embodiment of a spring nut according to the invention with a locking leg in a released position; and

FIG. 2 is a perspective view of the exemplary embodiment according to FIG. 1 in engagement with a bolt, the locking leg being in a closed position.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

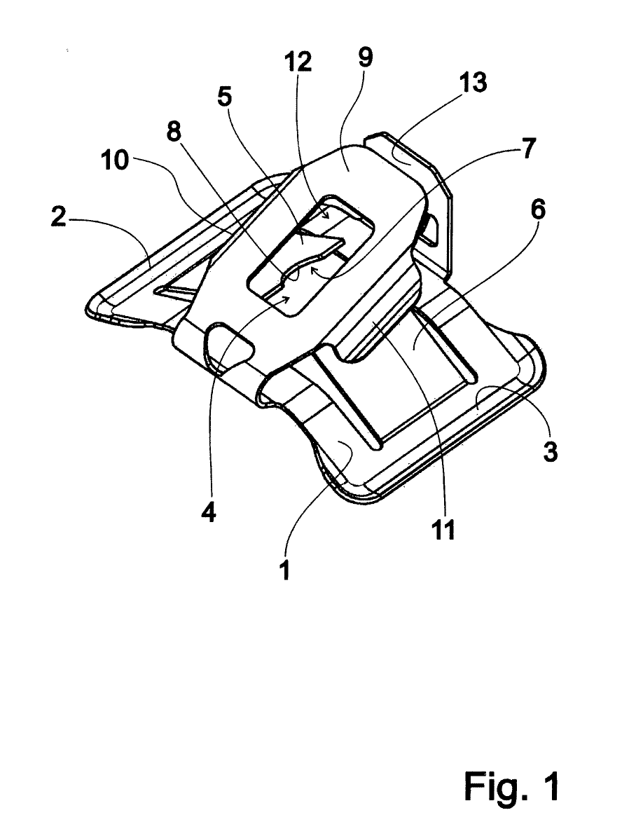

FIG. 1 is a perspective view of an exemplary embodiment of a spring nut according to the invention. The exemplary embodiment according to FIG. 1 is stamped from sheet metal, for example a steel sheet, and comprises a circumferential frame 1, which, proceeding from two edge-side foot portions 2, 3, is bent in a direction away from the plane of said foot portions 2, 3.

Configured as a recess in the inner region of the circumferential frame 1 is a substantially rectangular frame recess 4, into which protrude clamping legs 5, 6, each of which is attached to a respective foot portion 2, 3. The clamping legs 5, 6 approximately follow the conformation of connecting portions rising from the foot portions 2, 3, and are spaced apart from each other at their free ends directed away from the foot portions 2, 3. At these free ends, each of the clamping legs 5, 6 comprises an edge recess 7 having a circular-arc-shaped inner edge 8.

Resiliently attached in the central region of a connecting portion of frame 1 that extends between foot portions 2, 3 is a locking leg 9 that extends in the direction of the opposite connecting portion of the frame 1. Said locking leg 9 comprises, as elements of a lug arrangement, edge webs 10, 11 that are disposed on the edge sides located in the region of clamping legs 5, 6 and are bent over in the direction of clamping legs 5, 6. In addition, locking leg 9 is configured with a penetratingly engageable recess 12, which is preferably larger in width than the distance between the free ends of clamping legs 5, 6 and is approximately equal in length to the corresponding dimension of the frame recess 4.

Finally, the spring nut according to the illustrated exemplary embodiment comprises, as a part of a holding arrangement, a holding leg 13 that is attached to the central region of the connecting portion disposed opposite the root region of locking leg 9 and extends roughly at right angles in the direction of the free end of locking leg 9.

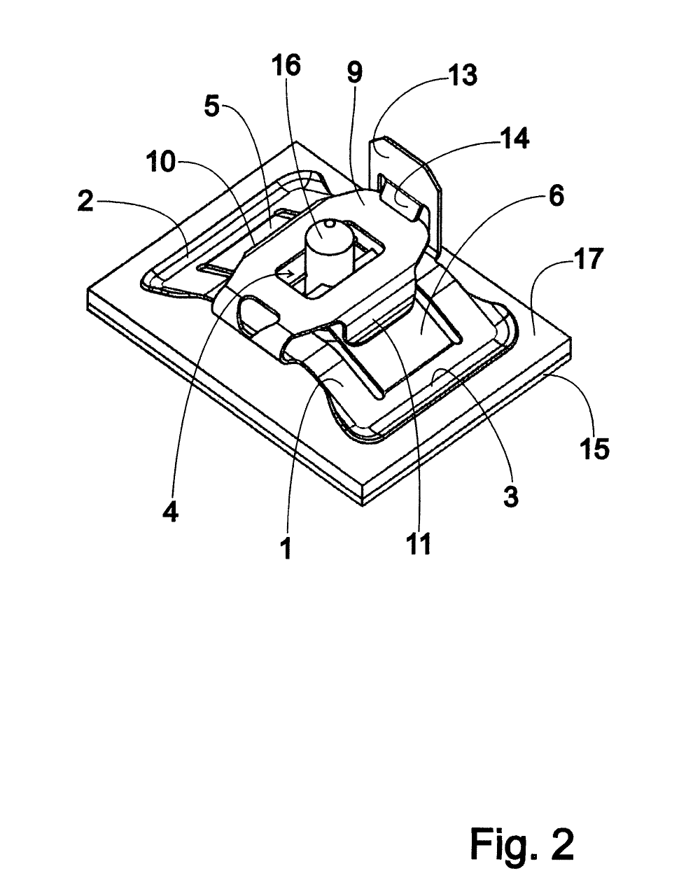

FIG. 2 is a perspective view of the exemplary embodiment according to FIG. 1, in a closed position of locking leg 9 in which the free end of locking leg 9 is engaged on its trailing surface by a protruding holding tab 14 formed onto holding leg 13. In the closed position, edge webs 10, 11 act on clamping legs 5, 6 in such a way that clamping legs 5, 6 exert a holding force, which is much higher than the mating force needed when the locking leg 9 is in the open, released position illustrated in FIG. 1. Clamping legs 5, 6 exert a holding force on a bolt 16 that is fixedly connected to a supporting part 15 and which is inserted in frame recess 4. Bolt 16 is dimensioned to fit the free ends of clamping legs 5, 6, and has a smooth outer wall, as illustrated here, or alternatively is provided with a fine or coarse thread. Advantageously, in the released position of locking leg 9, the free ends of clamping legs 5, 6 have a distance between them that is at least equal to a standard diameter of a bolt 16. To in some degree secure the spring nut while clamping leg 9 is still in the released position, the distance between the free ends of clamping legs 5, 6 is preferably smaller than a nominal diameter of a bolt 16.

As can be seen from FIG. 2, in the closed position of locking leg 9, for example an add-on part 17 can be connected to supporting part 15. To release the inventive spring nut, holding leg 13 need only be moved away from the free end of locking leg 9 until the engagement of holding tab 14 with the trailing surface of the free end of locking leg 9 is released. Locking leg 9 then springs away from the frame 1, thereby resulting in a withdrawal force which, again, is much lower than the holding force obtained in the closed position of the locking leg 9.

It is to be understood that the cycle of mounting, locking and removing the spring nut can be repeated as often as desired, within the limits of the long-term elasticity of the material of the spring nut, without altering the holding force in any practically relevant way.

In a non-illustrated improvement of the spring nut according to the invention, a bolt cover facing away from the frame 1 is usefully configured on the locking leg 9 to protect against injury.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-9. (canceled)

10. A spring nut adapted to be fastened to a bolt, said spring nut comprising:
a frame having a recess therein;
two resilient clamping legs mutually oppositely attached to said frame by a root region, said clamping legs each having a free end, said root regions directed away from each other, said free ends mutually confronting each other, said free ends protruding into said recess of said frame;
a locking leg bendably attached to said frame; and
a holding arrangement secured to said frame for engaging said locking leg in a closed position of said locking leg and thereby exerting a closing force on at least one said clamping leg for causing said spring nut to hold onto a said bolt.

11. The spring nut of claim 10 wherein said locking leg is connected to said frame by a connecting portion which is disposed midway between said root regions of said two clamping legs, said connecting portion exerting a closing force on said clamping legs.

12. The spring nut of claim 11 wherein said locking leg includes a lug which acts on one said clamping leg to generate said closing force.

13. The spring nut of claim 12 wherein said locking leg includes two edge webs that are bent in the direction of said clamping legs, the number of said edge webs being the same as the number of said clamping legs with which said locking leg cooperates, each respective said edge web acting on one said clamping leg.

14. The spring nut of claim 13 wherein, in a released position of said locking leg, the free ends of said clamping legs have a distance between them that is at least as great as a standard diameter of a said bolt.

15. The spring nut of claim 13 wherein the free ends of said clamping legs each comprises an edge recess with a circular-arc-shaped inner edge.

16. The spring nut of claim 12 wherein said holding arrangement comprises a resilient holding leg which is attached substantially at right angles to said frame and points in the direction of said locking leg, said locking leg including an engaging structure.

17. The spring nut of claim 16 wherein said engaging structure is spaced apart from the free end of said holding leg.

18. The spring nut of claim 16 wherein said engaging structure is a lug that engages the trailing surface of said locking leg in the closed position of said locking leg.
